(19) United States
(12) Patent Application Publication
(10) Pub. No.: US 2011/0307396 A1
(43) Pub. Date: Dec. 15, 2011

(54) Education Tool for Assessing Students

(75) Inventors: Michael Andrew Hewitt, South Jordan, UT (US); Douglas Michael Weber, Salt Lake City, UT (US); James Trenton Goble, South Jordan, UT (US)

(73) Assignee: MASTERYCONNECT LLC, South Jordan, UT (US)

(21) Appl. No.: 12/815,406

(22) Filed: Jun. 15, 2010

(51) Int. Cl. G06Q 50/00; G06Q 10/00; G06F 17/30; G06F 17/00; G06F 3/048; G09B 5/00; G06Q 99/00

(52) U.S. Cl. 705/317; 434/350; 705/319; 705/326; 715/227; 715/771; 707/802; 707/E17.044

(57) ABSTRACT

A computer-implemented method and system for managing student assessments may include: 1) receiving new assessments from a user base, 2) associating the new assessments with a standard learning objective, 3) storing the new assessment to a database of assessments, 4) providing the user base with searchable access to the database of assessments, the database of assessments filterable by the standard learning objective associated with each of the assessments, 5) receiving an assessment selection from a user within the user base, 6) rendering the selected assessment to the user so that the selected assessment can be used to assess students' competency level of the standard learning objective associated with the selected assessment. Various other methods, systems, and computer-readable media are also disclosed.

### BACKGROUND OF THE INVENTION

1. The Field of the Invention

The present invention relates generally to tools for assessing students. More specifically, the present invention relates to methods and systems for sharing assessments and associating them with standard learning objectives.

2. The Relevant Technology

In educational settings, various methods are used for determining a student's competency level for a class or subject. A traditional method of assessing students includes assigning a grade to each student, the most commonly used grading index in the U.S. educational system including letter grades A, B, C, D, and F. Alternatively a numerical scale may be used to grade a student, such as 0 through 4.0. The grade for each student is often determined according to percentages. For example, individual scores may be given for class attendance, homework completion, test averages, and the like. A weighted average of these variables may be used to compute a percentage, which is the index from which grades are determined.

In order to teach a class or subject, a teacher will often generate a lesson plan consisting of a series of predefined assignments and exams. The teacher typically administers and scores each assignment and exam in a predefined sequence. The scores from these assignments and exams can be weighted and tallied in order to determine the final grade. Although the final grade may provide a general indication of a student's overall understanding of a class or general subject matter, the grade often does not provide granular feedback regarding a student's competency level of specific topics or subjects. For example, a student may do very poorly on assignments or exams related to one topic, but do well on those related to other topics. In spite of the poor performance on one topic, the weighted average of all assessments may yield a high grade for the class. However, all too often, the student is never re-taught the topic for which the student performed poorly in an effort to adhere to the predefined lesson plan for the class.

One of the shortcomings of a predefined lesson plan is that it can be difficult to customize to students struggling on a specific topic, particularly since different students will often struggle with different topics. However, predefined lesson plans are still commonly used, in large part due to the difficulty in finding a sufficient number of tests, assignments, and other assessments for each topic such that multiple assessments may be administered when needed to ensure that each student adequately understands each topic. While many assessments may be available that relate to a general subject matter, each assessment is often focused on a slightly different nuance of the subject due to lack of standardization between schools, school districts, states, or other educational divisions from which the assessments originate.

As such, the instant disclosure identifies a need for systems and methods for managing student assessments. This disclosure also identifies a need for associating student assessments with learning objectives, and rendering the student assessments to teachers in a way that allows teachers to effectively assess the competency level of each of the learning objectives.

The subject matter claimed herein is not limited to embodiments that solve any disadvantages or that operate only in environments such as those described above. Rather, this background is only provided to illustrate one example technology area where some embodiments described herein may be practiced.

### BRIEF SUMMARY OF THE INVENTION

As will be described in greater detail below, the instant disclosure introduces a student assessment sharing mechanism that may enable users to upload assessments to be shared with other users within a user base, as well as access a database of shared assessments to be used to assess students' competency levels of a standard learning objective associated with the shared assessments. This disclosure also details various systems and methods for managing a teacher's class, including the ability to add a shared assessment directly to an objective tracker.

In one example, an example method for managing student assessments may include 1) receiving new assessments from a user base, 2) associating the new assessments with a standard learning objective, 3) storing the new assessment to a database of assessments, 4) providing the user base with searchable access to the database of assessments, the database of assessments filterable by the standard learning objective associated with each of the assessments, 5) receiving an assessment selection from a user within the user base, 6) rendering the selected assessment to the user so that the selected assessment can be used to assess students' competency level of the standard learning objective associated with the selected assessment.

The user base may include a closed network of instructors within a plurality of learning institutions, such as a school district, state, or any other group of learning institutions that may fall within the scope of a common group of standard learning objectives. In one embodiment, the closed network of instructors may include a social network, which may include a plurality of relationship ties between instructors within the closed network of instructors. The social network may include the ability to deliver real-time notifications between users within the social network, where one user may subscribe to the real-time notifications of one or more other users. For example, the real-time notifications may be generated when a user adds one of the new assessments.

The standard learning objectives may be collected from a rule-making body, and may be applicable to a plurality of learning institutions. The rule-making or governing body may include a state or federal (i.e., national) government, as well as authorities at a local level.

As will be explained in greater detail below, when a user selects one of the assessments from the database of assessments, in one embodiment, the selected assessment may automatically be associated with an objective tracker for the user. The objective tracker may be tied to the standard learning objective associated with the selected assessment and may be used to track the students' competency level of the standard learning objective tied to the objective tracker. A class tracker may further be provided for tracking all objectives that may be associated with a teacher's class. In one embodiment, separate objective trackers may be automatically generated for each of the standard learning objectives that are applicable to a class tracker.

In one embodiment, the competency level of each of the students may be displayed to a user using a color-coded visual depiction, in accordance with scores attained by each of the students on the assessments added to the student tracker. For example, the color-coded visual depiction of the competency level of each of the students may reflect the scores attained by each of the students relative to at least one scoring threshold level associated with the assessments.

In one embodiment, when a new assessment is received from a user, the new assessment may be added to the user's objective tracker. The new assessment may further be associated with one of the standard learning objectives and automatically stored to the database of assessments.

This Summary is not intended to identify key features or essential characteristics of the claimed subject matter, nor is it intended to be used as an aid in determining the scope of the claimed subject matter. Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example system for managing student assessments, class tracker data, and objective tracker data.

FIG. 2 is a block diagram of another example system for managing student assessments, class tracker data, and objective tracker data.

FIG. 3 is a flow diagram of an example method for managing student assessments.

FIG. 4 illustrates an example user interface for depicting an objective tracker.

FIG. 5 illustrates an example user interface for depicting a class tracker.

FIG. 6 is a block diagram of an example computing system capable of implementing one or more of the embodiments described and/or illustrated herein.

FIG. 7 is a block diagram of an example computing network capable of implementing one or more of the embodiments described and/or illustrated herein.

### DETAILED DESCRIPTION

In the following detailed description of the embodiments of the invention, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

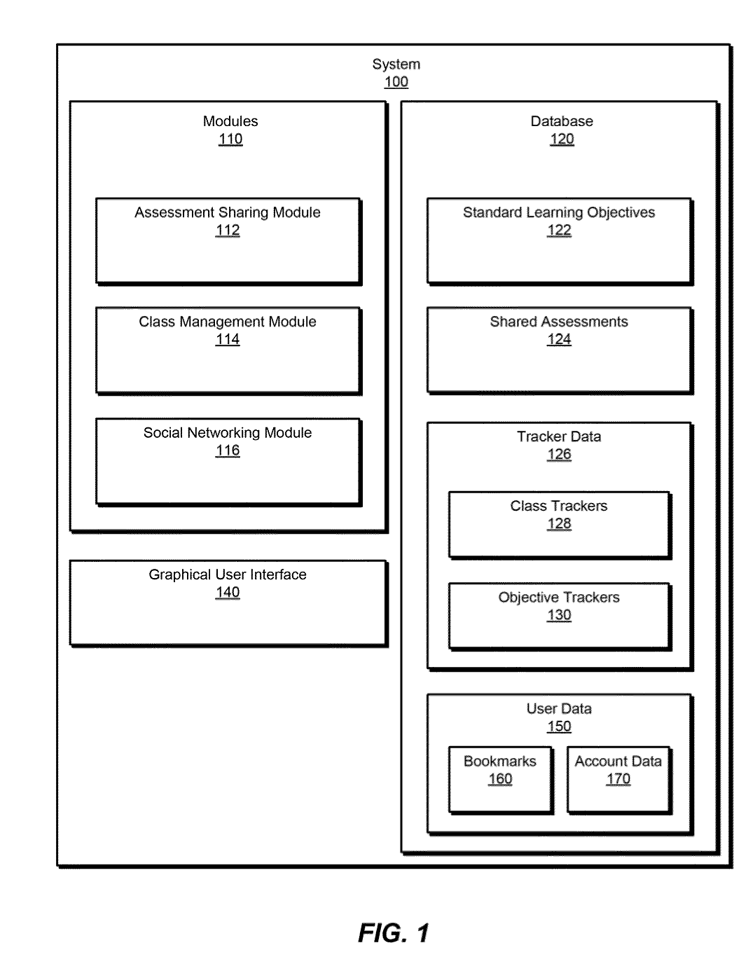

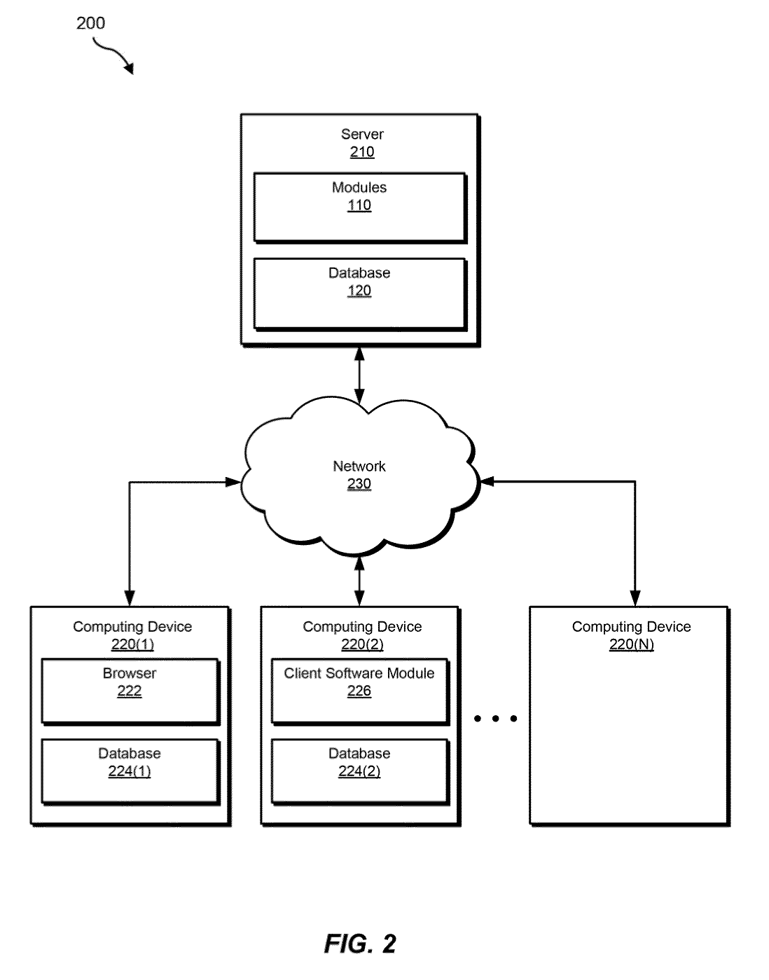

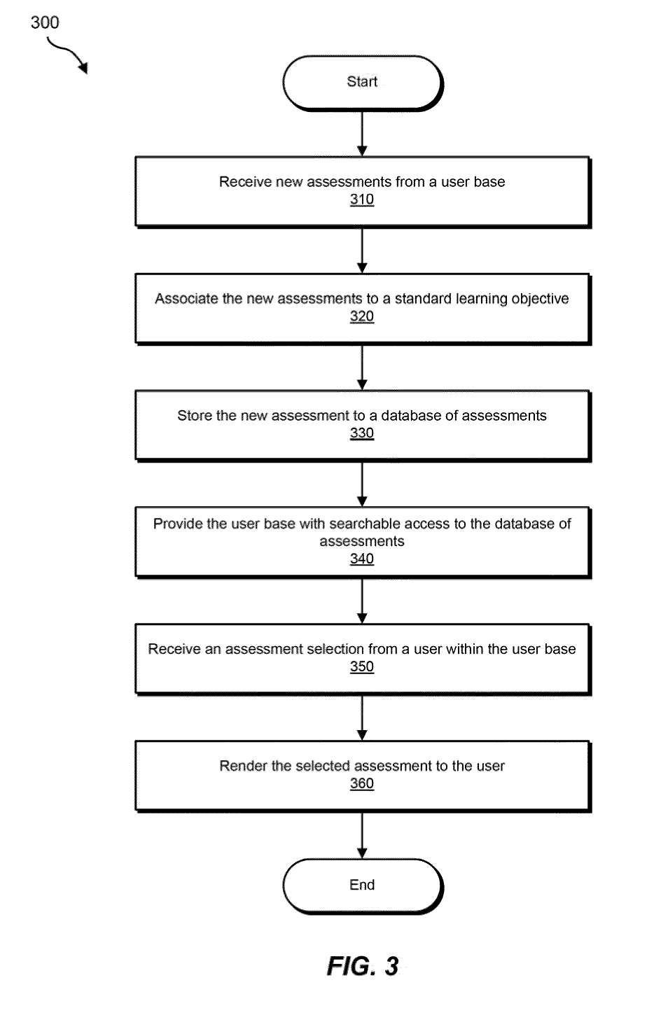

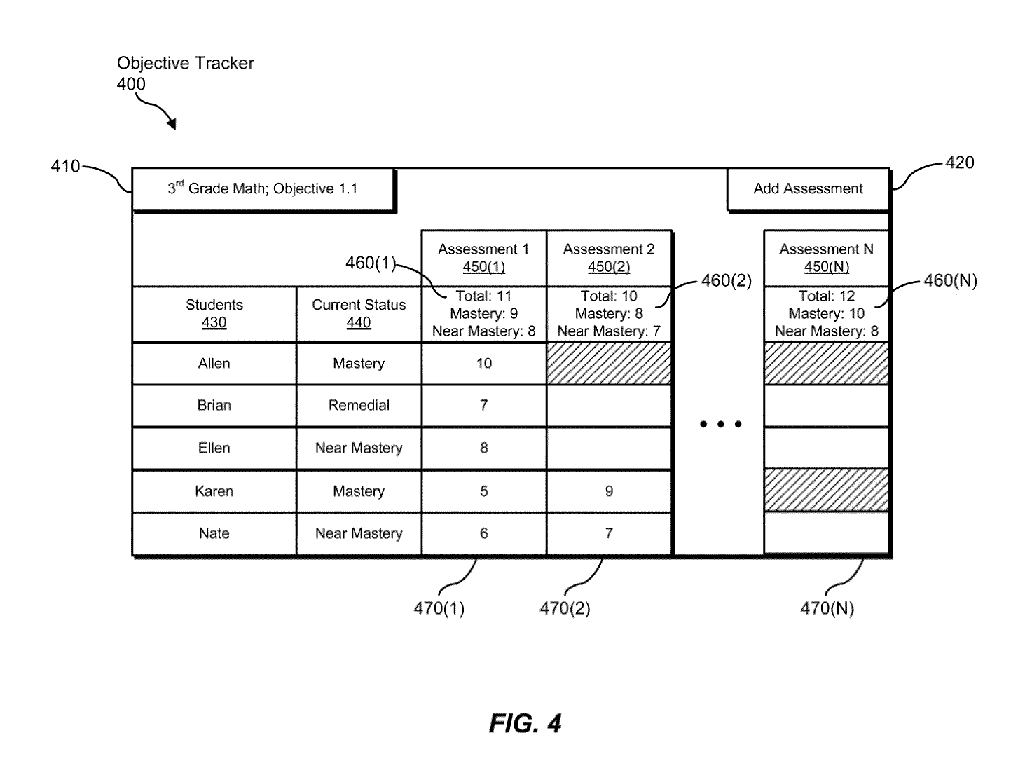

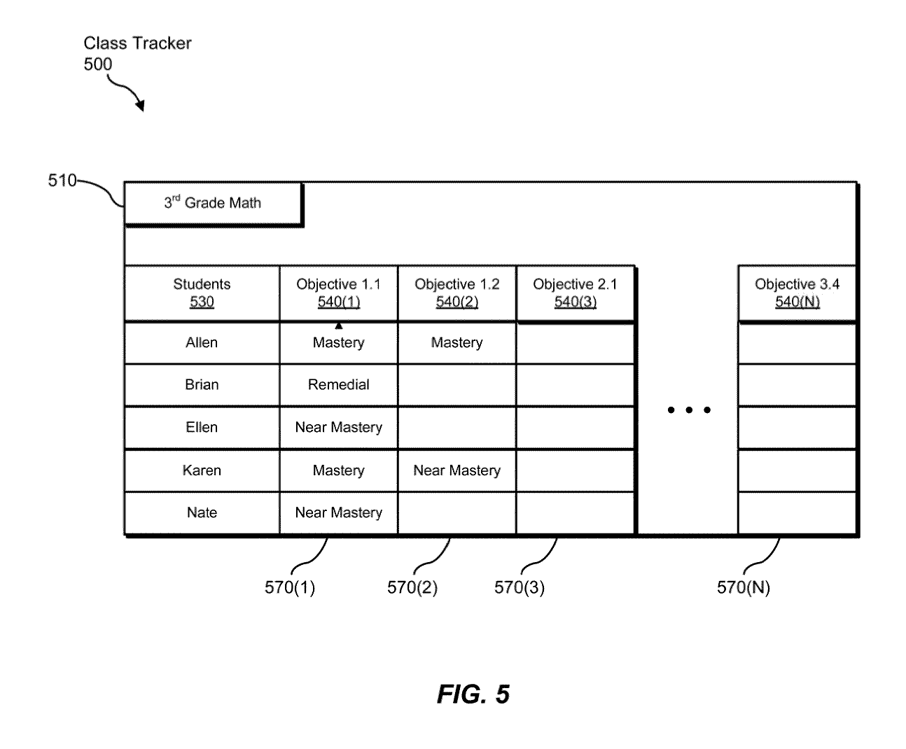

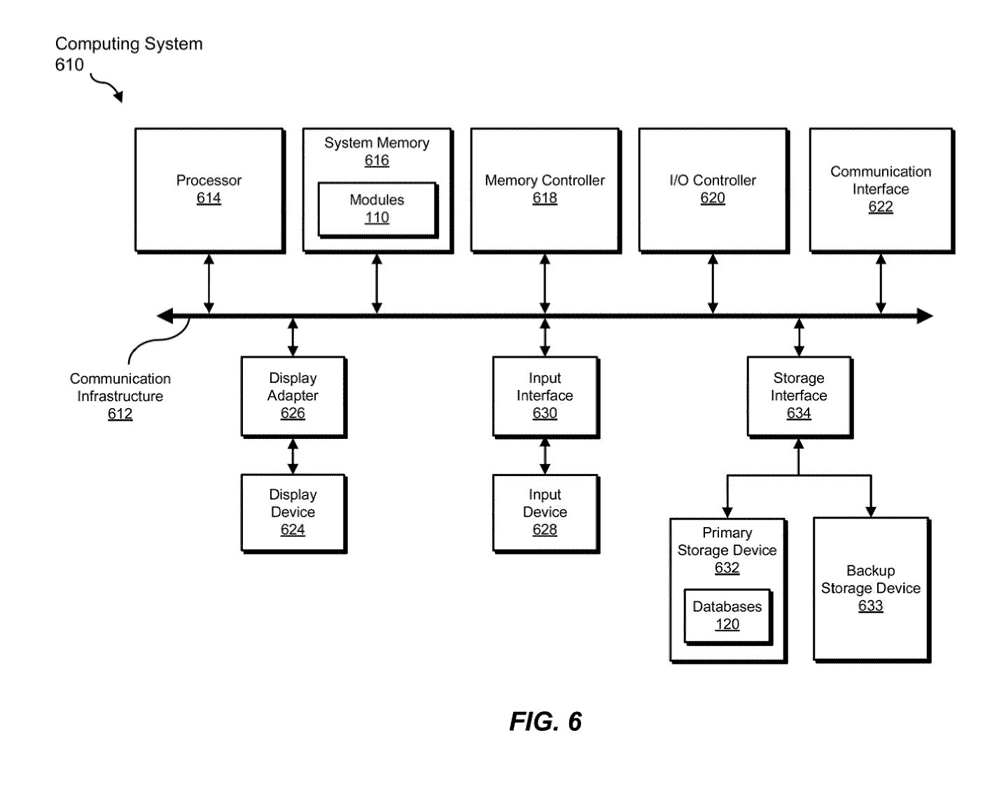

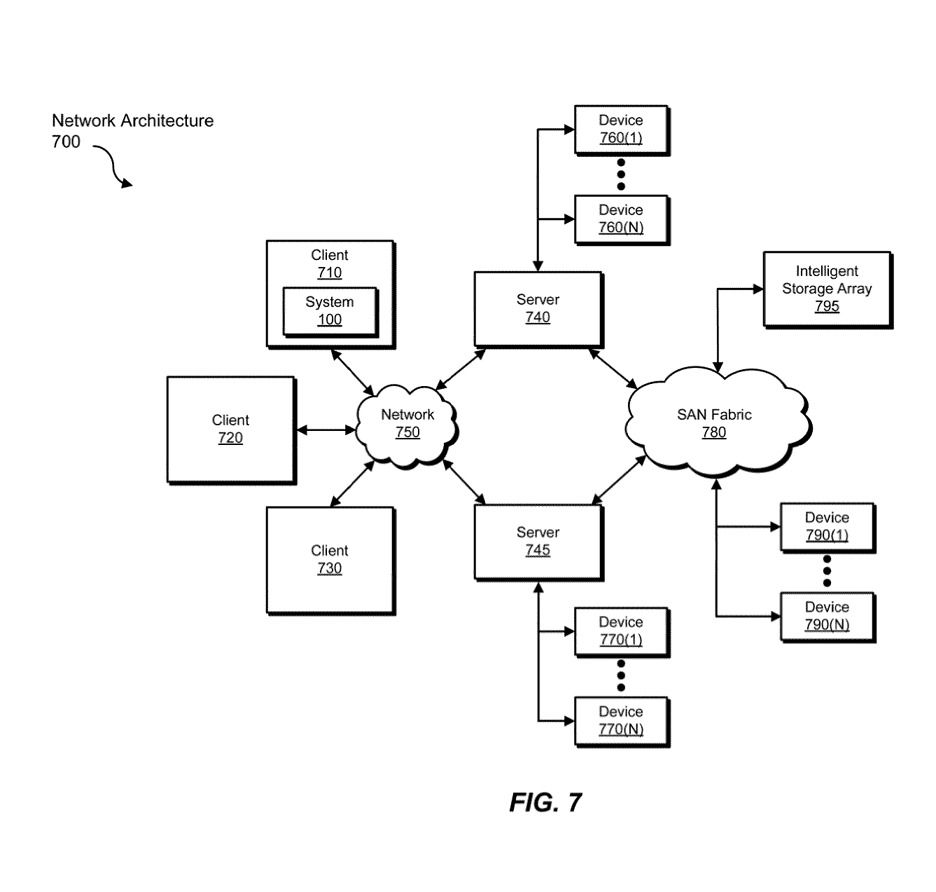

Example embodiments of the present invention, with reference to FIGS. 1-2, relate to systems for managing student assessments used to assess students' competency levels for standard learning objectives. Detailed descriptions of corresponding computer-implemented methods will also be provided in connection with FIG. 3. Additional description of example data tracking techniques will be provided with reference to FIGS. 4-5. In addition, detailed descriptions of an example computing system and network architecture capable of implementing one or more of the embodiments described herein will be provided in connection with FIGS. 6 and 7, respectively.

Referring now to FIG. 1, a block diagram is illustrated of an example embodiment of a system, denoted generally at 100, for managing student assessments. As illustrated in this figure, example system 100 may include one or more modules 110 for performing one or more tasks. For example, and as will be explained in greater detail below, example system 100 may include an assessment sharing module 112 programmed to receive assessments from a user base of system 100 and to provide the user base with access to the assessments stored within system 100. The example system 100 may also include a class management module 114 programmed to manage a user's classroom data, including students, learning objectives associated each class, assessments, and the students' competency level for the relevant standard learning objectives, as will be described in detail below. The example system 100 may also include a social networking module 116 to manage a social network of instructors, including relationship ties between instructors within the user base, as will be described in further detail below.

In certain embodiments, one or more of modules 110 in FIG. 1 may represent one or more software applications or programs that, when executed by a computing device, may cause the computing device to perform one or more tasks. For example, as will be described in greater detail below, one or more of modules 102 may represent software modules stored and configured to run on one or more computing devices, such as the devices illustrated in FIG. 2 (e.g., server 210, and/or computing devices 220(1)-(N)), computing system 610 in FIG. 6, and/or portions of example network architecture 700 in FIG. 7. One or more of modules 102 in FIG. 1 may also represent all or portions of one or more special-purpose computers configured to perform one or more tasks.

As illustrated in FIG. 1, example system 100 may also include one or more databases, such as database 120. In one example, database 120 may be configured to store standard learning objectives 122, shared assessments 124, tracker data 126, and/or user data 150, one or more of which may be received and/or collected from a plurality of computing devices, such as computing devices 220(1)-(N) in FIG. 2, as well as from other sources that may communicate with database 120 over the network 230 in FIG. 2.

Standard learning objectives 122 may represent a plurality of finite education-related benchmarks, each related to a specific subject matter. A student's competency level of any given standard learning objective 122 may be determined by administering one or more shared assessments 124 associated with the appropriate standard learning objective. Standard learning objectives 122 are typically established by a rule-making body and may be applicable to a plurality of learning institutions. Standard learning objectives may also be known to one of ordinary skill in the art as “core curriculum”, “core objectives”, “state core”, “national core curriculum”, “national standard”, “standard objectives”, and the like. Standard learning objectives 122 may be organized in accordance with grade level, subject matter, and the like. Standard learning objectives 122 may be established by a rule making body at any level, including at the national (i.e., federal) level, state level, city level, municipal level, county level, by a public or private school at any level (e.g., university, high school, middle school, elementary school, pre-school, and the like), at the school district level, and the like.

One example set of standard learning objectives 122 includes the state of Utah's “Elementary and Secondary School Core Curriculum”, as defined in Utah Administrative Code R277-700, as of May, 2010. By way of example, the Utah Core Curriculum is organized by subject matter and grade level. Each subject and grade is further subdivided by “standards”, which is further subdivided by “objectives.” Each standard includes a general educational topic, and each objective includes at least one more focused criteria that should be met by a student in order to demonstrate a requisite competency level of the objective. By way of example, Utah's Core Curriculum for 3rd Grade Mathematics, Standard 1, Objective 1 (i.e., “Objective 1.1”) reads as follows:

Standard 1: Students will understand the base-ten numeration system, place value concepts, simple fractions and perform operations with whole numbers.

Objective 1: Represent whole numbers up to 10,000, comprehend place value concepts, and identify relationships among whole numbers using base-ten models and symbolic notation.
a. Read, write, and represent whole numbers using standard and expanded form.
b. Demonstrate multiple ways to represent numbers using models and symbolic representations (e.g., fifty is the same as two groups of 25, the number of pennies in five dimes, or 75−25).
c. Identify the place and the value of a given digit in a four-digit numeral and round numbers to the nearest ten, hundred, and thousand.
d. Order and compare whole numbers on a number line and use the symbols <, >, ≠, and = when comparing whole numbers.
e. Identify factors and multiples of whole numbers.

The Utah Core Curriculum is provided by way of example only. It will be appreciated that standard learning objectives 122 may be provided by any rule-making body. Standard learning objectives 122 may be applicable to a plurality of learning institutions that fall within the scope of the establishing rule making body. For example, a national standard may apply to all schools subscribing to the national standard. Similarly, a state standard may be applicable to all public schools within the state.

In addition, shared assessments 124 may represent a variety of assessment tools, such as tests, examinations, quizzes, and the like. As will be described in greater detail below, shared assessments 124 stored within database 120 are received from the user base of the example system 100, and can be tied to, or associated with one or more standard learning objectives 122.

Tracker data 126 may represent information that can be used by a teacher, instructor, tutor, professor, or the like, for tracking the competency levels of students. Students may include students of all levels, apprentices, and the like. In the illustrated embodiment, tracker data 126 may include class trackers 128 and objective trackers 130. Class trackers 128 may represent all data used to track the competency level for one or more classes that are taught by a teacher. Similarly, objective trackers 130 may represent all data used to track the competency level of students with regards to a single learning objective stored in the standard learning objective data 122.

User data 150 may represent other data maintained by system 100 that may be relevant to a user. For example, user data 150 may include bookmarks 160, which may include previously selected shared assessments 124 that may be of interest to that user. A copy of each of the user's bookmarks 160 may be stored within user data 150, or alternatively, bookmarks 160 may simply store a reference or pointer to each of the shared assessments 124 selected by the user. User data 150 may also include account data 170, which may include user preferences, additional classroom-related data, and the like.

Database 120 may represent portions of a single database or computing device or a plurality of databases or computing devices. For example, database 120 may represent a portion of one or more of the devices illustrated in FIG. 2, computing system 610 in FIG. 6, and/or portions of example network architecture 700 in FIG. 7. Alternatively, database 120 in FIG. 1 may represent one or more physically separate devices capable of being accessed by a computing device, such as one or more of the devices illustrated in FIG. 2, computing system 610 in FIG. 6, and/or portions of example network architecture 700 in FIG. 7.

In addition to modules 110 and database 120, the example system 100 may also include graphical user interface 140 configured to receive a user requests for assessments stored in shared assessments 124 and to display the tracker data 124 and other information to the user.

The example system 100 in FIG. 1 may be deployed in a variety of ways. For example, all or a portion of example system 100 may represent portions of example system 200 in FIG. 2. As shown in FIG. 2, system 200 may include a plurality of computing devices 220(1)-(N) in communication with a server 210 via a network 230. In one embodiment, and as will be described in greater detail below, modules 110 from FIG. 1 may program server 210, to: 1) receive new assessments from a user base (e.g., users of computing devices 220(1)-(N)); 2) associate the new assessments to a standard learning objective (e.g., one of the standard learning objectives 122 stored in database 120 from FIG. 1); 3) store the new assessment to a database of assessments (e.g., shared assessments 124 in database 120 from FIG. 1); 4) provide the user base with searchable access to the database of assessments, the database of assessments filterable by the standard learning objective associated with each of the assessments; 5) receive an assessment selection from a user within the user base; 6) render the selected assessment to the user so that the selected assessment can be used to assess students' competency level of the standard learning objective associated with the selected assessment.

Computing devices 220(1)-(N) generally represent any type or form of computing device capable of reading computer-executable instructions. Examples of computing devices 220(1)-(N) include, without limitation, laptops, desktops, servers, cellular phones, personal digital assistants (PDAs), multimedia players, terminal servers, embedded systems, combinations of one or more of the same, example computing system 610 in FIG. 6, or any other suitable computing device. As will be described in greater detail below, computing devices 220(1)-(N) may include a browser 222 that can be used to access some or all of the features of the server 210. In one embodiment, computing devices 220(1)-(N) may include a client application 226 that accesses services on server 210, and may be used in addition to or as an alternative to the browser 222. In one embodiment, computing devices 220(1)-(N) may include a database 224(1)-(N) used for storing assessments created or used by the user of the computing devices 220(1)-(N), local copies of assessments downloaded by the user, and the like.

Server 210 generally represents any type or form of computing device or devices capable of collecting and aggregating assessments from thousands or potentially more computing devices in order to correlate the assessments with standard learning objectives, and allow a user base to search and access the assessments to be used for assessing student's competency level of the standard learning objectives.

Network 230 generally represents any medium or architecture capable of facilitating communication or data transfer. Examples of network 230 include, without limitation, an intranet, a wide area network (WAN), a local area network (LAN), a personal area network (PAN), the Internet, power line communications (PLC), a cellular network (e.g., a GSM Network), example network architecture 700 in FIG. 7, or the like. Network 230 may facilitate communication or data transfer using wireless or wired connections. In one embodiment, network 230 may facilitate communication between computing devices 220(1)-(N) and server 210.

FIG. 3 is a flow diagram of an example computer-implemented method 300 for managing student assessments. The steps shown in FIG. 3 may be performed by any suitable computer-executable code and/or computing system. In some embodiments, the steps shown in FIG. 3 may be performed by one or more of the components of system 100 in FIG. 1, system 200 in FIG. 2, computing system 610 in FIG. 6, and/or portions of example network architecture 700 in FIG. 7.

As illustrated in FIG. 3, one or more of the various systems described herein may receive 310 new assessments from a user base. For example, graphical user interface module 140 in FIG. 1 may, as part of browser 222 or client software module 226 in FIG. 2, enable a user within the user base to select an assessment that the user would like to upload and share with the user base of the example systems 100 and/or 200. The new assessment received from the user base may be received by the assessment sharing module 112, as part of server 210 in FIG. 2.

A “user base,” as used herein, may refer to any group of users of the example systems 100 and/or 200. The user base may be made up a learning community of instructors that provide the shared assessments 124 as well as consume the shared assessments, as described in further detail below. In one embodiment, the user base may include a closed network of users. For example, the closed network may include instructors within a plurality of learning institutions, where each of the learning institutions falls within the scope of a common core curriculum consisting of a collection of standard learning objectives 122, as described above. Similarly, if multiple states subscribe to a single national standard, a user base may be expanded to include teachers from each state using the national standard such that assessments can be shared and be used as effective tools for assessing students in classes taught by teachers from multiple states.

The systems described herein may perform step 310 in a variety of ways. In one example, the systems described herein may provide a client-side and/or server-side application that enables users to select an assessment to be uploaded to and received by system 200. The assessment selected by the user may include an assessment created by the user, or an assessment acquired by the user from a third-party source. In one example embodiment, the assessments selected by the user may be stored locally in database 224(1)-(N).

As further illustrated in FIG. 3, the systems described herein may associate 320 the new assessments with a standard learning objective. For example, after receiving the new assessment from the user base in step 310, assessment sharing module 112 may, as part of server 210 in FIG. 2, associate the new assessment with one of the standard learning objectives 122, stored in database 120 in FIG. 1.

The systems described herein may perform step 320 a variety of ways. In one example, upon receiving the new assessment from a user, graphical user interface module 140 in FIG. 1 may prompt the user to select a standard learning objective 122 to be associated with the new assessment. Assessment sharing module 112 may make the association between the new assessment and the selected standard learning objective 122 to indicate that the new assessment contains content for assessing students' competency level of the associated standard learning objective

In another example, assessment sharing module 112 may associate the new assessment with a standard learning objective automatically, based on the context in which the new assessment is received from the user. For example, and as will be described in further detail below, each user within the user base may maintain tracker data 126 for tracking class trackers 128 and objective trackers 130. As described above, class trackers 128 may include all data regarding the progress of each student with regards to each of the relevant standard learning objectives 122. Each objective tracker 130 may be tied to a specific standard learning objective 122 and contain data regarding the progress of each student with regards to the standard learning objective 122 tied to that objective tracker.

In one example, a user may be viewing a particular objective tracker 130 that is tied to standard learning objective ‘X.’ While viewing the objective tracker 130 tied to standard learning objective ‘X’, the user may be allowed to select a new assessment, for example, from a local database 224(1)-(N) in FIG. 2. Upon receiving the new assessment, assessment sharing module 112 may automatically associate the new assessment with standard learning objective ‘X’, due to the context in which the new assessment was received from the user.

In one embodiment, when a new assessment is uploaded from one of the user's objective trackers 130, in addition to being received by assessment sharing module 112, the new assessment is also added automatically to the objective tracker 130 being viewed by the uploading user when the new assessment was selected. The process of adding an assessment to an objective tracker 130 will be described in further detail below.

Returning to FIG. 3, the systems described herein may store 330 the new assessment received in step 320 to a database of assessments. For example, assessment sharing module 112 in FIG. 1 may, as part of server 200, store the new assessment received from the user base to the collection of shared assessments 124 stored in database 120 in FIG. 1.

As further illustrated in FIG. 3, one or more of the various systems described herein may provide 340 the user base with searchable access to the database of assessments. For example, assessment sharing module 112 in FIG. 1 may, as part of server 200, allow the user base to access some or all of shared assessments 124 stored in database 120.

The systems described herein may perform step 340 a variety of ways. In one example, shared assessments 124 may be displayed to users via graphical user interface 140 in FIG. 1, and may be sorted in accordance with one or more properties associated with the shared assessments 124 to facilitate selection of one or more desired assessments. For example, shared assessments 124 may be filterable by the standard learning objective 122 associated with each of the shared assessments 124. In other words, the user may request to view all shared assessments 124 that have been associated with standard learning objective ‘X’, and will accordingly be shown all shared assessments 124 associated with standard learning objective ‘X.’

Shared assessments 124 may be displayed to the user and organized according to various other criteria in addition to the associated standard learning objective, including grade level, subject, a user rating of each assessment, location of the uploading user, date of initial posting, most popular in terms of user downloads, selections, comments, and the like. By allowing the users to sort and search shared assessments by various criteria, the most popular or “best” assessments can be easily identified.

In another example, step 340 may also be performed by providing a user with access to shared assessments 124 based on the standard learning objective 122 tied to the objective tracker 130 being viewed, or most recently viewed, by the user, as will be described in further detail below in FIG. 5.

In accordance with present embodiment, the number of assessments that are accessible to the user base is dramatically increased in comparison to a traditional classroom environment. In a traditional classroom environment, the assessments accessible by a teacher are typically limited to those that are collected directly by the teacher, or manually distributed amongst teachers within a single school or district. Instead, and in accordance with the example embodiment, assessment sharing module 112 provides a teacher that is part of the learning community (i.e., user base) with access to all shared assessments 124 that have been uploaded by all other users within the learning community. Furthermore, the user base may quickly and easily locate and access an assessment of interest because the assessments may be filtered by the standard learning objective 122 and other criteria associated with each of the shared assessments 124.

Returning again to FIG. 3, the systems described herein may receive 350 an assessment selection from a user within the user base. For example, using computing device 220(1)-(N) in FIG. 2, a user may select a shared assessments 124 stored in database 120 in FIG. 1. The assessment selection may then be received by class management module 114, as part of server 200.

As further illustrated in FIG. 3, one or more of the various systems described herein may render 360 the selected assessment to the user. For example, class management module 114, as part of server 200, may provide the selected assessment to the user such that the selected assessment can be used to assess students' competency level of the standard learning objective 122 associated with the selected assessment.

The systems described herein may perform step 360 a variety of ways. In one example, class management module 114 may allow the user's computing device 220(1)-(N) to download an electronic copy of the selected assessment. The selected assessment may be stored locally in database 224(1)-(N), or in any location selected by the user. With the assessment now accessible by the user, the user is able to use the assessment to assess the user's student. For example, the user may simply print and administer the assessment to a class of students.

In another example, class management module 114 may render 360 the selected assessment to the user by adding the selected assessment to a personal database that is accessible by the user. For example, and in one embodiment, each user of system 100 may be provided with an account. As described previously, account data 170 may be stored at user data 150. User data 150 may also include bookmarks 160, which may include each assessment 124 selected or identified by the user. In one example, adding an assessment to a user's bookmarks 160 may include placing a copy of the selected assessment into the user's bookmarks 160. In another example, the user's bookmarks 160 may include a reference back to the appropriate assessments that may be stored in shared assessments 124, as part of database 120. As is described in more detail below, at least one of user data 150, tracker data 126, shared assessments 124, standard learning objectives 122 may be stored in a location that is remote from the end user's computing device, including within a remote server, cloud-computing or network-based environment.

In another example, class management module 114 may render 360 the selected assessment to the user by automatically adding the selected assessment to an objective tracker 130 for the user. The objective tracker to which the selected assessment is added may be tied to the standard learning objective 122 associated with the selected assessment. Therefore, in accordance with the present example, there is no need for the user to manually correlate a selected assessment to an appropriate subject matter, topic, class, or grade level. Instead, and in accordance with the present embodiment, the assessments will automatically be tied to the appropriate objective tracker 130 used to track the students' competency level of the standard learning objective 122 tied to the objective tracker 130 and associated with the selected assessment.

FIG. 4 is provided to further illustrate one example objective tracker 400, which may correspond to an objective tracker 130 stored in database 120 in FIG. 1. As will be appreciated by one of ordinary skill in the art, the objective trackers 130 may be displayed to a user in a variety of formats, and the example objective tracker 400 is merely one example embodiment. The illustrated objective tracker 400 is tied to example standard learning objective “3^{rd} Grade Math; Objective 1.1” (depicted at 410). Therefore, example objective tracker 400 is used to assess students' 430 competency level of “Objective 1.1” for 3^{rd} Grade Math”. This may be accomplished by adding assessments 450(1)-(N) to objective tracker 400 and administering one or more of the assessments 450(1)-(N) to students 430, and logging the scores 470(1)-(N) attained by each student on each of the administered assessment 450(1)-(N).

A user may add an assessment to objective tracker 400 by selecting an “Add Assessment” icon 420. Upon selecting “Add Assessment” icon 420, the user may be provided with various mechanisms for selecting an assessment to be added to objective tracker 400. For example, a user may select an assessment from shared assessments 124 in FIG. 1. In the illustrated example of FIG. 4, assessment sharing module 112 may automatically provide to the user with all shared assessments 124 that are associated with standard learning objective 1.1. for 3^{rd} Grade Math 410. Upon selecting one or more of the shared assessments 124, the selected assessment may be automatically added to objective tracker 400, and the added assessments are displayed on objective tracker 400 at 450(1)-(N). As depicted in FIG. 5, a user may be allowed to add any number of assessments 450(1)-(N) to any given objective tracker 400.

In another example, upon selecting “Add Assessment” icon 420, a user may add an assessment from a local storage location. In accordance with the present example, and referring again to FIG. 2, a user of computing device 220(1)-(N) may identify an assessment stored in database 224(1)-(N). Upon identifying the assessment stored in database 224(1)-(N), the identified assessment may be added to the objective tracker 400 in FIG. 4 at 450(1)-(N). In one embodiment, in addition to adding the selected assessment 450(1)-(N) to the appropriate objective tracker 400, assessment sharing module 112 in FIG. 1 may also associate the received new assessment to the appropriate standard learning objective 122 (“3^{rd} Grade Math; Objective 1.1” 410 in the FIG. 4 example) and store the received new assessment to shared assessments 124 stored in database 122.

In another example, upon selecting “Add Assessment” icon 420, a user may add an assessment from a personal database of previously stored or selected assessments, such as bookmarks 160, which may be included as part of user data 150. For example, a user may select one or more shared assessments 124, but may not necessarily want to add the selected shared assessment to an objective tracker 130 at the time the assessment is selected. Instead, the selected assessment may be included in bookmarks 160, as described previously. The user may access the assessments included in bookmarks 160 location at a later time, and add one or more of the assessments stored therein to the appropriate objective tracker 130. Referring again to FIG. 4, the assessment selected from the user's bookmarks 160 may be added as one of the assessments 450(1)-(N).

As further illustrated in the FIG. 4 example, each assessment 450(1)-(N) added to objective tracker 400 may be assigned at least one scoring threshold level 460(1)-(N). In the present example, each assessment includes a “Total” possible score, and is also assigned a “Mastery” score and a “Near Mastery” score. A “Mastery” score, if attained by a student 430, may indicate that the student has achieved a requisite competency level of the corresponding standard learning objective 410. A “Near Mastery” score, if attained by a student 430, may indicate that the student has achieved an average competency level of the corresponding standard learning objective 410. A student attaining any score below “Near Mastery” may indicate that the student has a remedial competence level of the corresponding standard learning objective 410. Threshold levels 460(1)-(N) may be assigned by the user who created the assessment, and may be customized by each user once it is added to an objective tracker 400. Furthermore, the names and meanings of each scoring threshold level 460(1)-(N) may vary, and are only provided herein as one example embodiment.

After administering one of the assessments 450(1)-(N), a user (e.g., teacher) may log the students' scores 470(1)-(N). For example, in the FIG. 4 example, all students 430 have taken “Assessment 1” 450(1), and scores 470(1) have been logged by the user. In accordance with threshold scores 460(1) for “Assessment 1” 450(1), a current status 440 for each student 430 may automatically be updated to indicate the competence level of the students for the standard learning objective 410. In the current example, only Allen obtained a “Mastery” score on Assessment 1, and his status 440 is updated accordingly. In the present example, score entry cells 470(2)-(N) for subsequent assessments 450(2)-(N) may be fully or partially blocked out (e.g., hashed or grayed out) to indicate that Allen does not require additional testing for standard learning objective 410 since the requisite competence level has already been achieved. In one embodiment, the hashed or grayed out score entry cells 470(2)-(N) may be overridden by a user in the event that the teacher wishes to administer additional assessments to a “Mastery” level student.

Since the remaining students Brian, Ellen, Karen and Nate did not achieve a “Mastery” level score on “Assessment 1” 450(1), the user may provide further training to these students, add additional assessments 450(2)-(N), and reassess the remaining students. In the FIG. 4 example, Karen and Nate have taken “Assessment 2” 450(2), with Karen achieving a “Mastery” score and Nate achieving a “Near Mastery” score, in accordance with thresholds scores 460(2) for “Assessment 2” 450(2). Current status 440 for Karen and Nate have been updated to indicate said competence levels, and score entry cells 470(N) has been hashed out to indicate that Karen does not require additional testing for standard learning objective 410 since the requisite competence level has already been achieved. Brian and Ellen have not yet taken additional assessments, and therefore their current status 440 is listed as “Remedial” and “Near Mastery”, respectively, in accordance with their scores on “Assessment 1” 450(1) relative to thresholds scores 460(1).

In one embodiment, objective tracker 400 may display a color-coded visual depiction of the competency level of each of the students 430 in accordance with scores 470(1)-(N) attained by each of the students on the assessments 450(1)-(N). For example, graphical user interface 140 in FIG. 1 may display a color-coded visual depiction of the competency level of each of the students 430 in accordance with scores 470(1)-(N) attained by each of the students relative to scoring threshold levels 460(1)-(N). One example technique for color-coding objective tracker 400 displays a color scheme in the current status column 440 in accordance with the competence level of each student 430, such as green for “Mastery”, yellow for “Near Mastery” and red for “Remedial” status. In addition or as an alternative to color coding current status column 440, graphical user interface 140 may further color code a portion or the entirety of each assessment scoring cell 470(1)-(N) based on the score achieved relative to the respective threshold levels 460(1)-(N). For example, each of the assessment scoring cells 470(1)-(N) may include a dot that indicates each student's score on the respective assessment 450(1)-(N), and each “Current Status” cell 440 may be color-coded in accordance with each student's best overall score, or most recently attained score, on the administered assessments 450(1)-(N). As will be appreciated by one of ordinary skill in the art, the color-coding schemes described herein are merely examples, and multiple color-coding combinations and schemes may be employed to visually depict the competency level of each student 430.

As introduced previously, in addition to objective trackers 130 in FIG. 1, tracker data 126 may also include class trackers 128. Class trackers 128 may represent all data used to track the competency level for one or more classes that are taught by a teacher. Class trackers 128 may include separate class trackers for each class taught by one or more teachers. Each class tracker 128 may include a listing of all students in the class being tracked. In one embodiment, for a given class tracker 128, a teacher may manage multiple objective trackers 130, each tied to a separate standard learning objective 122 that is relevant to the class tracker 128. In one embodiment, upon creating a class tracker 128 for a given class, class management module 114 may automatically populate the created class tracker 128 with all objective trackers 130 that are applicable to the class tracker.

To further describe the concept of a class tracker 128, FIG. 5 is provided to illustrate one example class tracker 500, which may correspond to a class tracker 128 stored in database 120 in FIG. 1. As will be appreciated by one of ordinary skill in the art, the class trackers 128 may be displayed to a user in a variety of formats, and the example class tracer 500 is merely one example embodiment. The illustrated class tracker 500 may be used by a teacher to track a “3^{rd} Grade Math” class (depicted at 510). Class tracker 500 includes students 530 in the 3^{rd} Grade Math class 510. Students 530 may be manually added to class tracker 500 by a teacher, or may alternatively be added automatically from a previously established class tracker or objective tracker.

Class tracker 500 may also include a listing of objectives 540(1)-(N). Objectives 540(1)-(N) may be selected from standard learning objectives 122 in FIG. 1. As described previously, objectives 540(1)-(N) may include a core standard created by any rule-making body, including a national, state, or local education rule-making authority, and the like. In one embodiment, when a user creates class tracker 500, class management module in FIG. 1 may automatically populate class tracker 500 with the appropriate standard learning objectives 122, as depicted by the objectives 540(1)-(N). In another embodiment, the user may manually select and add the appropriate standard learning objectives 122 to class tracker 500.

By populating class tracker 500 with the applicable objectives 540(1)-(N), a teacher can quickly determine how to focus daily, weekly, monthly, and even yearly lesson plans such that students 530 can obtain a “Mastery” competence level for each objective 540(1)-(N). In addition, and in one embodiment, each of the objectives 540(1)-(N) listed in class tracker 500 may be linked to an objective tracker, such as objective tracker 400 in FIG. 4. For example, a user may select “Objective 1.1” 540(1) in the “3^{rd} Grade Math” 510 class tracker 500, which may navigate the user to objective tracker 400 for the “3^{rd} Grade Math; Objective 1.1” 410. In this way, a teacher easily has access to any number of shared assessments 124 that are directly related to the objectives 540(1)-(N) that are relevant to a given class tracker 500.

The present disclosure leverages the broad applicability of standard learning objectives 122 by allowing a large user base to create and share assessments 124 associated with standard learning objectives 122 that are applicable to a plurality of learning institutions. Rather than manually distributing assignments, tests and quizzes among teachers within a single school or district, the present disclosure relates to the ability to electronically share objective-specific assessments 124 with teachers all over a district, state or country.

Referring again to FIG. 1, example system 100 may further include social networking module 116, which manages relationship ties between instructors within a closed network of instructors. The term “social-network,” as used herein, may refer to any type or form of computing (e.g., web-based) service that enables users (e.g., instructors) to establish, build, and/or reflect social relationships ties between users. In one embodiment, social networking module 116 may provide a mechanism through which users of system 100 may interact with one another, share ideas, comments, and assessments 124, and the like with one another.

Social networking module 116 may also manage a subscription service, where a first user may establish connections to other users within the user base by subscribing to real-time notifications or feeds generated by one or more of the other users example system 100. The real-time notification may include any number education-related communications. For example, the first user may discover that the second user routinely adds high-quality new assessments to the database of shared assessments 124. The first user, via social networking module 116, may subscribe to the real-time notifications of the second user, so that the first user will receive a real-time notification when the second user adds subsequent new assessments to the database of shared assessments 124. The real-time notifications delivered to subscribing users may include other types of notifications from a user's connections, including comments left by a user, interests identified by the user, assessments added by a user to the user's objective tracker 130, the connection adding a subscription to another user's real-time notifications, and the like. The real-time notifications may be delivered to a subscribing user using any number of delivery mechanisms, including a web-based live feed, a desktop-based notification system, Skype, instant messaging (IM), short messaging service (SMS text messaging), multimedia messaging service (MMS), email, and the like.

FIG. 6 is a block diagram of an example computing system 610 capable of implementing one or more of the embodiments described and/or illustrated herein. Computing system 610 broadly represents any single or multi-processor computing device or system capable of executing computer-readable instructions. Examples of computing system 610 include, without limitation, workstations, laptops, client-side terminals, servers, distributed computing systems, handheld devices, or any other computing system or device. In its most basic configuration, computing system 610 may include at least one processor 614 and a system memory 616.

Processor 614 generally represents any type or form of processing unit capable of processing data or interpreting and executing instructions. In certain embodiments, processor 614 may receive instructions from a software application or module. These instructions may cause processor 614 to perform the functions of one or more of the example embodiments described and/or illustrated herein. For example, processor 614 may perform and/or be a means for performing, either alone or in combination with other elements, one or more of the steps described herein. Processor 614 may also perform and/or be a means for performing any other steps, methods, or processes described and/or illustrated herein.

System memory 616 generally represents any type or form of volatile or non-volatile storage device or medium capable of storing data and/or other computer-readable instructions. Examples of system memory 616 include, without limitation, random access memory (RAM), read only memory (ROM), EEPROM, flash memory, or any other suitable memory device. Although not required, in certain embodiments computing system 610 may include both a volatile memory unit (such as, for example, system memory 616) and a non-volatile storage device (such as, for example, primary storage device 632, as described in detail below). In one example, one or more of modules 102 from FIG. 1 may be loaded into system memory 616.

In certain embodiments, example computing system 610 may also include one or more components or elements in addition to processor 614 and system memory 616. For example, as illustrated in FIG. 6, computing system 610 may include a memory controller 618, an Input/Output (I/O) controller 620, and a communication interface 622, each of which may be interconnected via a communication infrastructure 612. Communication infrastructure 612 generally represents any type or form of infrastructure capable of facilitating communication between one or more components of a computing device. Examples of communication infrastructure 612 include, without limitation, a communication bus (such as an ISA, PCI, PCIe, or similar bus) and a network.

Memory controller 618 generally represents any type or form of device capable of handling memory or data or controlling communication between one or more components of computing system 610. For example, in certain embodiments memory controller 618 may control communication between processor 614, system memory 616, and I/O controller 620 via communication infrastructure 612. In certain embodiments, memory controller 618 may perform and/or be a means for performing, either alone or in combination with other elements, one or more of the steps or features described and/or illustrated herein.

I/O controller 620 generally represents any type or form of module capable of coordinating and/or controlling the input and output functions of a computing device. For example, in certain embodiments I/O controller 620 may control or facilitate transfer of data between one or more elements of computing system 610, such as processor 614, system memory 616, communication interface 622, display adapter 626, input interface 630, and storage interface 634. I/O controller 620 may be used, for example, to perform and/or be a means for performing, either alone or in combination with other elements, one or more of the steps described herein. I/O controller 620 may also be used to perform and/or be a means for performing other steps and features set forth in the instant disclosure.

Communication interface 622 broadly represents any type or form of communication device or adapter capable of facilitating communication between example computing system 610 and one or more additional devices. For example, in certain embodiments communication interface 622 may facilitate communication between computing system 610 and a private or public network including additional computing systems. Examples of communication interface 622 include, without limitation, a wired network interface (such as a network interface card), a wireless network interface (such as a wireless network interface card), a modem, and any other suitable interface. In at least one embodiment, communication interface 622 may provide a direct connection to a remote server via a direct link to a network, such as the Internet. Communication interface 622 may also indirectly provide such a connection through, for example, a local area network (such as an Ethernet network), a personal area network, a telephone or cable network, a cellular telephone connection, a satellite data connection, or any other suitable connection.

In certain embodiments, communication interface 622 may also represent a host adapter configured to facilitate communication between computing system 610 and one or more additional network or storage devices via an external bus or communications channel. Examples of host adapters include, without limitation, SCSI host adapters, USB host adapters, IEEE 1394 host adapters, SATA and eSATA host adapters, ATA and PATA host adapters, Fibre Channel interface adapters, Ethernet adapters, or the like. Communication interface 622 may also allow computing system 610 to engage in distributed or remote computing. For example, communication interface 622 may receive instructions from a remote device or send instructions to a remote device for execution. In certain embodiments, communication interface 622 may perform and/or be a means for performing, either alone or in combination with other elements, one or more of the steps disclosed herein. Communication interface 622 may also be used to perform and/or be a means for performing other steps and features set forth in the instant disclosure.

As illustrated in FIG. 6, computing system 610 may also include at least one display device 624 coupled to communication infrastructure 612 via a display adapter 626. Display device 624 generally represents any type or form of device capable of visually displaying information forwarded by display adapter 626. Similarly, display adapter 626 generally represents any type or form of device configured to forward graphics, text, and other data from communication infrastructure 612 (or from a frame buffer, as known in the art) for display on display device 624.

As illustrated in FIG. 6, example computing system 610 may also include at least one input device 628 coupled to communication infrastructure 612 via an input interface 630. Input device 628 generally represents any type or form of input device capable of providing input, either computer or human generated, to example computing system 610. Examples of input device 628 include, without limitation, a keyboard, a pointing device, a speech recognition device, or any other input device. In at least one embodiment, input device 628 may perform and/or be a means for performing, either alone or in combination with other elements, one or more of the steps disclosed herein. Input device 628 may also be used to perform and/or be a means for performing other steps and features set forth in the instant disclosure.

As illustrated in FIG. 6, example computing system 610 may also include a primary storage device 632 and a backup storage device 633 coupled to communication infrastructure 612 via a storage interface 634. Storage devices 632 and 633 generally represent any type or form of storage device or medium capable of storing data and/or other computer-readable instructions. For example, storage devices 632 and 633 may be a magnetic disk drive (e.g., a so-called hard drive), a floppy disk drive, a magnetic tape drive, an optical disk drive, a flash drive, CD-ROM, or the like. Storage interface 634 generally represents any type or form of interface or device for transferring data between storage devices 632 and 633 and other components of computing system 610. In one example, database 120 from FIG. 1 may be stored in primary storage device 632.

In certain embodiments, storage devices 632 and 633 may be configured to read from and/or write to a removable storage unit configured to store computer software, data, or other computer-readable information. Examples of suitable removable storage units include, without limitation, a floppy disk, a magnetic tape, an optical disk, a flash memory device, CD-ROM, or the like. Storage devices 632 and 633 may also include other similar structures or devices for allowing computer software, data, or other computer-readable instructions to be loaded into computing system 610. For example, storage devices 632 and 633 may be configured to read and write software, data, or other computer-readable information. Storage devices 632 and 633 may also be a part of computing system 610 or may be a separate device accessed through other interface systems.

In certain embodiments, storage devices 632 and 633 may be used, for example, to perform and/or be a means for performing, either alone or in combination with other elements, one or more of the steps disclosed herein. Storage devices 632 and 633 may also be used to perform and/or be a means for performing other steps and features set forth in the instant disclosure.

Many other devices or subsystems may be connected to computing system 610. Conversely, all of the components and devices illustrated in FIG. 6 need not be present to practice the embodiments described and/or illustrated herein. The devices and subsystems referenced above may also be interconnected in different ways from that shown in FIG. 6. Computing system 610 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The phrase “computer-readable medium” generally refers to any form of device, carrier, or medium capable of storing or carrying computer-readable instructions. Examples of computer-readable media include, without limitation, transmission-type media, such as carrier waves, and physical media, such as magnetic-storage media (e.g., hard disk drives and floppy disks), optical-storage media (e.g., CD- or DVD-ROMs), electronic-storage media (e.g., solid-state drives and flash media), and other distribution systems.

The computer-readable medium containing the computer program may be loaded into computing system 610. All or a portion of the computer program stored on the computer-readable medium may then be stored in system memory 616 and/or various portions of storage devices 632 and 633. When executed by processor 614, a computer program loaded into computing system 610 may cause processor 614 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 610 may be configured as an application specific integrated circuit (ASIC) adapted to implement one or more of the example embodiments disclosed herein.

FIG. 7 is a block diagram of an example network architecture 700 in which client systems 710, 720, and 730 and servers 740 and 745 may be coupled to a network 750. Client systems 710, 720, and 730 generally represent any type or form of computing device or system, such as example computing system 610 in FIG. 6.

Similarly, servers 740 and 745 generally represent computing devices or systems, such as application servers or database servers, configured to provide various database services and/or run certain software applications. Network 750 generally represents any telecommunication or computer network including, for example, an intranet, a wide area network (WAN), a local area network (LAN), a personal area network (PAN), or the Internet. In one example, client systems 710, 720, and/or 730 and/or servers 740 and/or 745 may include system 100 from FIG. 1.

As illustrated in FIG. 7, one or more storage devices 760(1)-(N) may be directly attached to server 740. Similarly, one or more storage devices 770(1)-(N) may be directly attached to server 745. Storage devices 760(1)-(N) and storage devices 770(1)-(N) generally represent any type or form of storage device or medium capable of storing data and/or other computer-readable instructions. In certain embodiments, storage devices 760(1)-(N) and storage devices 770(1)-(N) may represent network-attached storage (NAS) devices configured to communicate with servers 740 and 745 using various protocols, such as NFS, SMB, or CIFS.

Servers 740 and 745 may also be connected to a storage area network (SAN) fabric 780. SAN fabric 780 generally represents any type or form of computer network or architecture capable of facilitating communication between a plurality of storage devices. SAN fabric 780 may facilitate communication between servers 740 and 745 and a plurality of storage devices 790(1)-(N) and/or an intelligent storage array 795. SAN fabric 780 may also facilitate, via network 750 and servers 740 and 745, communication between client systems 710, 720, and 730 and storage devices 790(1)-(N) and/or intelligent storage array 795 in such a manner that devices 790(1)-(N) and array 795 appear as locally attached devices to client systems 710, 720, and 730. As with storage devices 760(1)-(N) and storage devices 770(1)-(N), storage devices 790(1)-(N) and intelligent storage array 795 generally represent any type or form of storage device or medium capable of storing data and/or other computer-readable instructions.

In certain embodiments, and with reference to example computing system 610 of FIG. 6, a communication interface, such as communication interface 622 in FIG. 6, may be used to provide connectivity between each client system 710, 720, and 730 and network 750. Client systems 710, 720, and 730 may be able to access information on server 740 or 745 using, for example, a web browser or other client software. Such software may allow client systems 710, 720, and 730 to access data hosted by server 740, server 745, storage devices 760(1)-(N), storage devices 770(1)-(N), storage devices 790(1)-(N), or intelligent storage array 795. Although FIG. 7 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 740, server 745, storage devices 760(1)-(N), storage devices 770(1)-(N), storage devices 790(1)-(N), intelligent storage array 795, or any combination thereof. All or a portion of one or more of the example embodiments disclosed herein may also be encoded as a computer program, stored in server 740, run by server 745, and distributed to client systems 710, 720, and 730 over network 750. Accordingly, network architecture 700 may perform and/or be a means for performing, either alone or in combination with other elements, one or more of the steps disclosed herein. Network architecture 700 may also be used to perform and/or be a means for performing other steps and features set forth in the instant disclosure.

As detailed above, computing system 610 and/or one or more components of network architecture 700 may perform and/or be a means for performing, either alone or in combination with other elements, one or more steps of the example method for managing student assessments, as described in FIG. 3.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system.

In some embodiments, these software modules may configure a computing system to perform one or more of the example embodiments disclosed herein.

In addition, one or more of the modules described herein may transform data, physical devices, and/or representations of physical devices from one form to another. For example, assessment sharing module 112 in FIG. 1 may transform a property or characteristic of shared assessments 124, and class management module 114 in FIG. 1 may transform a property or characteristic of one or more of class trackers 128 and objective trackers 130.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A system for managing student assessments, the system comprising:
at least one database configured to:
store a list of standard learning objectives;
store assessments;
an assessment sharing module programmed to:
receive new assessments from a user base, associate the new assessments with one of the standard learning objectives, and store the new assessments to the at least one database, each of the new assessments containing content for assessing students' competency level of the associated standard learning objective;
provide the user base with searchable access to the assessments;
a class management module programmed to:
receive an assessment selection from a user within the user base;
render the selected assessment to the user use so that the selected assessment can be used to assess students' competency level of the standard learning objective associated with the selected assessment;
wherein the assessment sharing module and the class management module are executable by at least one processor.

2. The system of claim 1, wherein the user base is a closed network of instructors within a plurality of learning institutions.

3. The system of claim 2, further comprising a social networking module programmed to manage a social network of instructors comprising a plurality of relationship ties between instructors within the closed network of instructors.

4. The system of claim 3, wherein the social networking module is further configured to manage a subscription of a first instructor within the social network to real-time notifications of a second instructor within the social network, and to deliver the real-time notifications to the first instructor, the real-time notifications including education-related actions taken by the second instructor.

5. The system of claim 4, wherein the education-related actions taken by the second instructor includes the second instructor uploading one of the new assessments.

6. The system of claim 1, wherein the list of standard learning objectives is established by a rule-making body and are applicable to a plurality of learning institutions.

7. The system of claim 1, wherein the list of standard learning objectives is established by a governing body including at least one of:
a state government;
a national government;
wherein the list of standard learning objectives is applicable to a plurality of learning institutions.

8. The system of claim 1, wherein the class management module is further configured to automatically add the selected assessment to an objective tracker for the user, the objective tracker tied to the standard learning objective associated with the selected assessment and used to track the students' competency level of the standard learning objective tied to the objective tracker.

9. The system of claim 8, wherein for each of the users within the user base, the class management module is further programmed to manage:
at least one class tracker comprising:
a plurality of students;
separate objective trackers, each of the objective trackers tied to one of the standard learning objectives that are applicable to the at least one class tracker and configured to track the students' competency level of the standard learning objective tied to the objective trackers.

10. The system of claim 8, the system further comprising a user interface module configured to depict the student tracker as a table, the table comprising:
each of the students within the class;
the assessments that are selected by the user and automatically added to the student tracker by the class management module;
a color-coded visual depiction of the competency level of each of the students for the standard learning objective tied to the tracker according to scores attained by each of the students on the assessments added to the student tracker.

11. The system of claim 8, wherein the class management module is further programmed to receive one of the new assessments from local storage of the user and add the received new assessment to the student tracker for the user.

12. A computer-implemented method for managing student assessments, at least a portion of the method being performed by a computing device comprising at least one processor, the method comprising:
receiving new assessments from a user base;
associating the new assessments with a standard learning objective;
storing the new assessment to a database of assessments;
providing the user base with searchable access to the database of assessments, the database of assessments filterable by the standard learning objective associated with each of the assessments;
receiving an assessment selection from a user within the user base;
rendering the selected assessment to the user so that the selected assessment can be used to assess students' competency level of the standard learning objective associated with the selected assessment.

13. The method of claim 12, wherein receiving new assessments from a user base comprises receiving a new assessment from an instructor within a closed network of instructors within a plurality of learning institutions.

14. The method of claim 13, further comprising establishing a social network comprising a plurality of relationship ties between instructors within the closed network of instructors.

15. The method of claim 14, further comprising delivering real-time notifications to a first instructor within the social network, the real-time notifications including information regarding education-related actions taken by a second instructor within the social network, wherein the first instructor subscribes to the real-time notifications of the second instructor.

16. The method of claim 15, wherein delivering real-time notifications to a first instructor comprises generating a real-time notification to the first instructor when one of the new assessments is received from the second instructor.

17. The method of claim 12, further comprising generating a list of standard learning objectives by collecting standard learning objective data from a rule-making body, wherein the list of standard learning objectives is applicable to a plurality of learning institutions.

18. The method of claim 12, further comprising generating a list of standard learning objectives by collecting standard learning objective data from a governing body, the governing body including at least one of:
a state government;
a national government;
wherein the list of standard learning objectives is applicable to at least a portion of a plurality of learning institutions falling within the authority of the governing body.

19. The method of claim 12, wherein rendering the selected assessment to the user further comprises automatically adding the selected assessment to an objective tracker for the user, the objective tracker tied to the standard learning objective associated with the selected assessment and used to track the students' competency level of the standard learning objective tied to the objective tracker.

20. The method of claim 19, further comprising automatically generating separate objective trackers for each of the standard learning objectives that are applicable to a class tracker, wherein each of the objective trackers is tied to one of the standard learning objectives and is configured to track the students' competency level of the standard learning objective tied to the objective trackers.

21. The method of claim 19, further comprising displaying a color-coded visual depiction of the competency level of each of the students in accordance with scores attained by each of the students on the assessments added to the student tracker.

22. The method of claim 21, further comprising:
assigning each of the assessments at least one scoring threshold level;
wherein displaying a color-coded visual depiction of the competency level of each of the students comprises displaying a color-coded visual depiction of the competency level of each of the students in accordance with scores attained by each of the students relative to the at least one scoring threshold level.

23. The method of claim 19, further comprising:
receiving one of the new assessments from of the user;
adding the received new assessment to the user's objective tracker.

24. A computer-readable-storage medium comprising one or more computer-executable instructions that, when executed by at least one processor of a computing device, cause the computing device to:
receive new assessments from a user base;
associate the new assessments with a standard learning objective;
store the new assessment to a database of assessments;
provide the user base with searchable access to the database of assessments, the database of assessments filterable by the standard learning objective associated with each of the assessments;
receive an assessment selection from a user within the user base;
render the selected assessment to the user so that the selected assessment can be used to assess students' competency level of the standard learning objective associated with the selected assessment.
